(19) United States
(12) Patent Application Publication
(10) Pub. No.: US 2011/0262026 A1
(43) Pub. Date: Oct. 27, 2011

(54) INSPECTION APPARATUS AND DEFECT DETECTION METHOD USING THE SAME

(75) Inventor: Fumio HORI, Tokyo (JP)

(73) Assignee: OLYMPUS CORPORATION, Tokyo (JP)

(21) Appl. No.: 13/091,291

(22) Filed: Apr. 21, 2011

(30) Foreign Application Priority Data
Apr. 26, 2010 (JP) 2010-101475

(51) Int. Cl. G06K 9/00

(52) U.S. Cl. 382/141

(57) ABSTRACT

An inspection apparatus includes: a feature detection section for detecting first feature portions of at least two objects among a plurality of objects from images based on a first condition; a feature discrimination section for discriminating a first feature portion of a first object and a first feature portion of a second object based on the first feature portions of the at least two objects; a defect detection section for detecting a first defect portion of the first object and a first defect portion of the second object based on the first feature portions of the first object and the second object; and a display section for displaying information indicative of the first defect portion of the first object and information indicative of the first defect portion of the second object together with the images.

This application claims benefit of Japanese Application No. 2010-101475 filed in Japan on Apr. 26, 2010, the contents of which are incorporated by this reference.

### BACKGROUND OF THE INVENTION

1. Field of the Invention

The present invention relates to an inspection apparatus and a defect detection method using the inspection apparatus, and more particularly to an inspection apparatus capable of easily recognizing existence or nonexistence, an amount, and a size of a defect of an object to be inspected as well as a plurality of kinds of defects existing on a plurality of blades and a defect detection method using the inspection apparatus.

2. Description of the Related Art

Conventionally, endoscope apparatuses as nondestructive inspection apparatuses have been used for a nondestructive inspection performed on an object to be inspected such as an aircraft engine, a boiler, or the like. A user inserts an insertion section of an endoscope apparatus into an object to be inspected and identify an abnormal part such as a scar by checking an image of an object displayed on a display section.

An endoscope apparatus which automatically detects abnormal parts determines whether an object to be inspected is non-defective or defective by comparing previously prepared non-defective image data (hereinafter referred to as non-defective model) with image data of the object to be inspected and determines that the object to be inspected is normal if there is no difference in both of the image data.

The endoscope apparatus disclosed in the Japanese Patent Application Laid-Open Publication No. 2005-55756 includes image discrimination means adapted to determine that an object to be inspected is normal in a case where the shape of the image data of the object to be inspected is a straight line or a gentle curve and determine that the object to be inspected is abnormal in a case where the shape of the image data is other than the above, thereby enabling abnormal detection by the image processing in which creation of the comparison target corresponding to the non-defective model is eliminated.

### SUMMARY OF THE INVENTION

According to one aspect of the present invention, it is possible to provide an inspection apparatus that acquires images of a plurality of objects to be inspected, which includes: a feature detection section for detecting first feature portions of at least two objects among the plurality of objects from the images, based on a first condition; a feature discrimination section for discriminating a first feature portion of a first object and a first feature portion of a second object based on the first feature portions of the at least two objects; a defect detection section for detecting a first defect portion of the first object and a first defect portion of the second object based on the first feature portion of the first object and the first feature portion of the second object; and a display section for displaying information indicative of the first defect portion of the first object and information indicative of the first defect portion of the second object together with the images.

### BRIEF DESCRIPTION OF THE DRAWINGS

FIG. 1 is a view illustrating a configuration of a blade inspection system according to an embodiment of the present invention.

FIG. 2 is a block diagram illustrating a configuration of an endoscope apparatus 3.

FIG. 3 is an illustration diagram of a main window 50 of defect inspection software.

FIG. 4 is a flowchart for describing a flow of operation of the defect inspection software.

FIG. 5 is a flowchart for describing initialization processing in step S3 in FIG. 4.

FIG. 6 is a flowchart for describing video display processing in step S5 in FIG. 4.

FIG. 7 is a flowchart for describing still image capturing processing in step S6 in FIG. 4.

FIG. 8 is a flowchart for describing video image capturing processing in step S7 in FIG. 4.

FIG. 9 is a flowchart for describing inspection setting processing in step S8 in FIG. 4.

FIG. 10 is a flowchart for describing defect inspection processing in step S9 in FIG. 4.

FIG. 11 is a flowchart for describing chipping detection processing.

FIG. 12 is a view of a read-out frame image 60.

FIG. 13 is a view of an edge image A63 converted from a grayscale image.

FIG. 14 is a view of a binary image 64 converted from the edge image A63.

FIG. 15 is a view of a thin-line image A65 converted from the binary image 64.

FIG. 16 is a view of a dilation image 67 converted from a thin-line image B66.

FIG. 17 is a view of an edge image B69 generated from an edge region image 68.

FIG. 18 is a view of a divided edge image 70 generated from the edge image B69.

FIG. 19 is a view of a circle approximation image 71 in which a circle is approximated to each of the divided edges in the divided edge image 70.

FIG. 20 is a view of an edge image C74 generated by removing predetermined divided edges from the divided edge image 70.

FIG. 21 is a view of defect data.

FIG. 22 is a view showing that defect data (chipping) is superimposed on an endoscope video.

FIG. 23 illustrates a binary image 64a subjected to the binarization processing in step S84.

FIG. 24 illustrates an edge image C74a subjected to edge removal processing in step S95.

FIG. 25 is a view showing that defect data (delamination) is superimposed on the endoscope video in step S98.

FIG. 26 illustrates a binary image 64b subjected to the binarization processing in the step S84.

FIG. 27 illustrates an edge image C74b subjected to the edge removal processing in the step S95.

FIG. 28 is a view showing that defect data (chipping and delamination) is superimposed on the endoscope video in step S98.

FIG. 29A shows a browse window displayed when a browse button 56 is depressed.

FIG. 29B shows another example of the browse window displayed when the browse button 56 is depressed.

FIG. 29C shows yet another example of the browse window displayed when the browse button 56 is depressed.

FIG. 30 is a view showing a configuration example of a blade inspection system according to a modified example of the present embodiment.

FIG. 31 is a view showing another configuration example of a blade inspection system according to the modified example of the present embodiment.

FIG. 32 is a block diagram describing a configuration example of PC 6.

### DETAILED DESCRIPTION OF THE PREFERRED EMBODIMENTS

Hereinafter, detailed description will be made on an embodiment of the present invention with reference to the drawings.

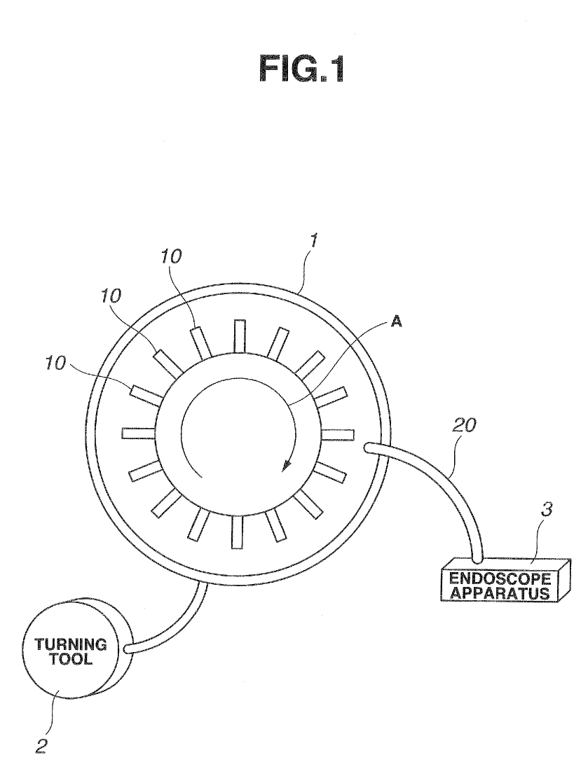

FIG. 1 is a view illustrating a configuration of a blade inspection system according to the present embodiment. As shown in FIG. 1, a plurality of turbine blades 10 as objects to be inspected are periodically arranged at predetermined intervals in a jet engine 1. Note that the objects are not limited to the turbine blades 10, but may be compressor blades, for example. In addition, the jet engine 1 is connected with a turning tool 2 which turns the turbine blades 10 in a rotational direction A at a predetermined speed. In the present embodiment, during capturing of the images of the turbine blades 10, the turbine blades are constantly turned by the turning tool 2.

In the present embodiment, an endoscope apparatus 3 is used for obtaining the images of the turbine blades 10. Inside the jet engine 1, an endoscope insertion section 20 of the endoscope apparatus 3 is inserted. The video of the turning turbine blades 10 is captured by the endoscope insertion section 20. In addition, defect inspection software program (hereinafter, referred to as defect inspection software) for detecting the defect of the turbine blades 10 in real time is stored in the endoscope apparatus 3.

Defects detected by the defect inspection software include two kinds of defects, that is, “chipping” (a first defect portion) and “delamination” (a second defect portion). “Chipping” means the state where a part of the turbine blades is chipped and lost. “Delamination” means the state where the surfaces of the turbine blades 10 become thin. The “delamination” includes both the state where only the surfaces of the turbine blades 10 are thinly peeled and the state where the surfaces of the turbine blades 10 are deeply hollowed.

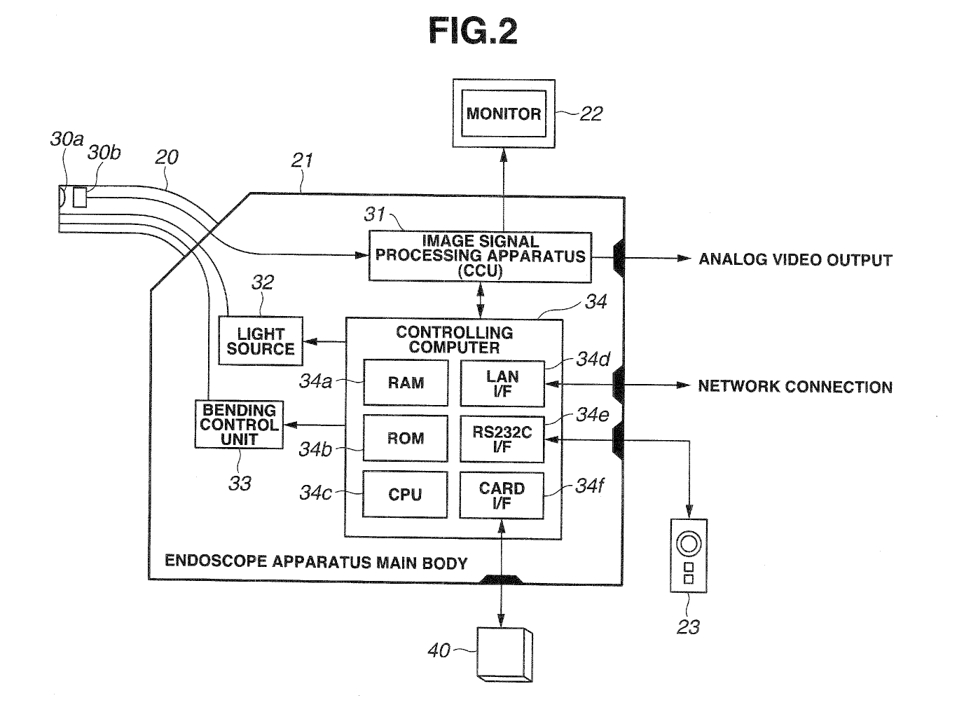

FIG. 2 is a block diagram illustrating the configuration of the endoscope apparatus 3. As shown in FIG. 2, the endoscope apparatus 3 includes the endoscope insertion section 20, an endoscope apparatus main body 21, a monitor 22, and a remote controller 23. An objective optical system 30a and an image pickup device 30b are incorporated in a distal end of the endoscope insertion section 20. In addition, the endoscope apparatus main body 21 includes an image signal processing apparatus (CCU) 31, a light source 32, a bending control unit 33, and a controlling computer 34.

The objective optical system 30a condenses the light from an object and forms an image of the object on an image pickup surface of the image pickup device 30b. The image pickup device 30b photoelectrically converts the image of the object to generate an image pickup signal. The image pickup signal outputted from the image pickup device 30b is inputted to the image signal processing apparatus 31.

The image signal processing apparatus 31 converts the image pickup signal outputted from the image pickup device 30b into a video signal such as an NTSC signal and supplies the video signal to the controlling computer 34 and the monitor 22. Furthermore, the image signal processing apparatus 31 can output, as needed, an analog video signal from a terminal to outside.

The light source 32 is connected to the distal end of the endoscope insertion section 20 through an optical fiber and the like, and is capable of irradiating light outside. The bending control unit 33 is connected to the distal end of the endoscope insertion section 20, and is capable of bending a bending portion at the distal end of the endoscope insertion section 20 in up, down, left, and right directions. The light source 32 and the bending control unit 33 are controlled by the controlling computer 34.

The controlling computer 34 includes a RAM 34a, a ROM 34b, a CPU 34c, and a LAN OF 34d, an RS232C I/F 34e and a card I/F 34f as external interfaces.

The RAM 34a is used for temporarily storing data such as image information and the like which are necessary for operation of software. The ROM 34b stores the software for controlling the endoscope apparatus 3, and also stores the defect inspection software to be described later. The CPU 34c performs arithmetic operations and the like for various controls by using the data stored in the RAM 34a, according to the instruction code from the software stored in the ROM 34b.

The LAN I/F 34d is an interface for connecting the endoscope apparatus to an external personal computer (hereinafter, referred to as external PC) via a LAN cable, and is capable of outputting the video information outputted from the image signal processing apparatus 31 to the external PC. The RS 232C I/F 34e is an interface for connecting the endoscope apparatus to the remote controller 23. Various operations of the endoscope apparatus 3 can be controlled by the operation of the remote controller 23 by the user. The card I/F 34f is an interface to and from which various memory cards as recording media are attachable/detachable. In the present embodiment, a CF card 40 is attachable/detachable. The user attaches the CF card 40 to the card I/F 34f, thereby capable of retrieving the data such as image information stored in the CF card 40 or recording the data such as image information into the CF card 40 by the control of the CPU 34c.

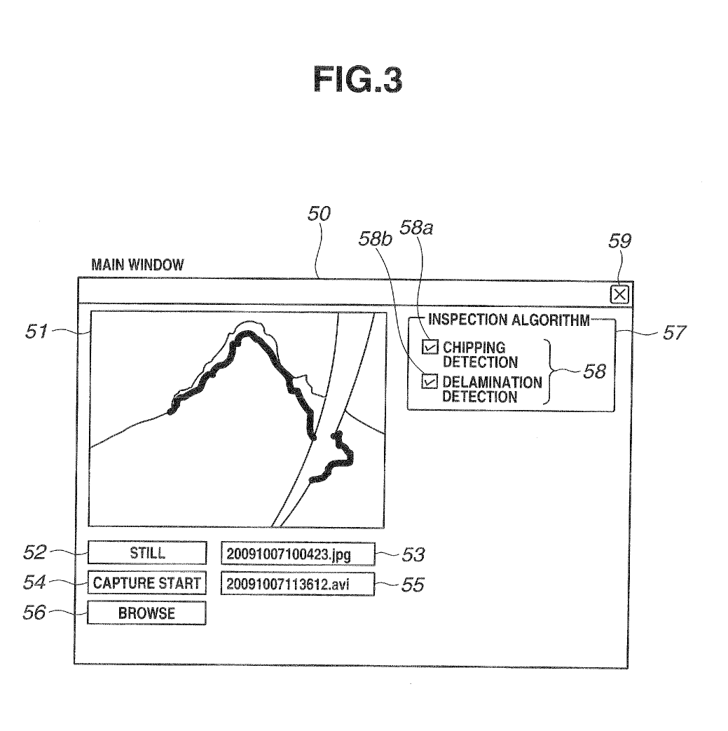

FIG. 3 is an illustration diagram of a main window 50 of the defect inspection software. The main window 50 is a window displayed first on the monitor 22 when the user activates the defect inspection software.

The display of the main window 50 is performed according to the control by the CPU 34c. The CPU 34c generates a graphic image signal (display signal) for displaying the main window 50 and outputs the generated signal to the monitor 22.

Furthermore, when displaying the video captured in the endoscope apparatus 3 (hereinafter referred to as endoscope video) on the main window 50, the CPU 34c performs processing of superimposing the image data processed by the image signal processing apparatus 31 on the graphic image signal, and outputs the processed signal to the monitor 22.

The user can perform endoscope video browsing, defect inspection result browsing, inspection algorithm setting, parameter setting, still image file saving, video image file saving, and the like, by operating the main window 50 via the remote controller 23. Hereinafter, functions of various Graphical User Interfaces (GUIs) will be described.

A live video box 51 is a box in which an endoscope video is displayed. When the defect inspection software is activated, the endoscope video is displayed in real time in the live video box 51. The user can browse the endoscope video in the live video box 51.

A still button 52 is a button for acquiring a still image. When the still button 52 is depressed, an image for one frame of the endoscope video, which was captured at the timing when the still button 52 was depressed, is saved as a still image file in the CF card 40. The processing performed when the still button 52 was depressed will be detailed later.

A still image file name box 53 is a box in which the file name of the acquired still image is displayed. When the still button 52 is depressed, the file name of the still image file saved at the timing when the still button 52 was depressed is displayed.

A capture start button 54 is a button for acquiring a video image. When the capture start button 54 is depressed, recording of the endoscope video into the video image file is started. At that time, the display of the capture start button 54 is changed from “capture start” to “capture stop”. When the capture stop button 54 is depressed, the recording of the endoscope video into the video image file is stopped, and the video image file is saved in the CF card 40. At that time, the display of the capture stop button 54 is changed from “capture stop” to “capture start”. In addition, when defect is detected from the object, defect data to be described later is recorded in the video image file together with the endoscope video. The processing performed when the capture start button 54 is depressed will be detailed later.

A video image file name box 55 is a box in which the file name of the acquired video image is displayed. When the capture start button 54 is depressed, the file name of the video image file started to be recorded at the timing when the capture start button was depressed is displayed.

A browse button 56 is a button for allowing browse of the still image file and video image file saved in the CF card 40. When the browse button 56 is depressed, a browse window to be described later is displayed, which allows the user to browse the saved still image file and video image file.

An inspection algorithm box 57 is a box in which various settings of inspection algorithm are performed. The inspection algorithm is an image processing algorithm applied to the endoscope video in order to perform defect inspection of the object to be inspected. In the inspection algorithm box 57, an inspection algorithm selection check box 58 is arranged.

The inspection algorithm selection check box 58 is a check box for selecting an inspection algorithm to be used. The user can select an inspection algorithm by putting a check mark in the inspection algorithm selection check box 58. The inspection algorithm selection check box 58 includes two kinds of check boxes, that is, a “chipping detection” check box and “delamination detection” check box. A chipping detection check box 58a is selected when the chipping detection algorithm is used. A delamination detection check box 58b is selected when the delamination detection algorithm is used. The chipping detection algorithm and the delamination detection algorithm will be detailed later.

A close button (“x” button) 59 is a button to terminate the defect inspection software. When the close button 59 is depressed, the main window 50 is hidden and the operation of the defect inspection software is terminated.

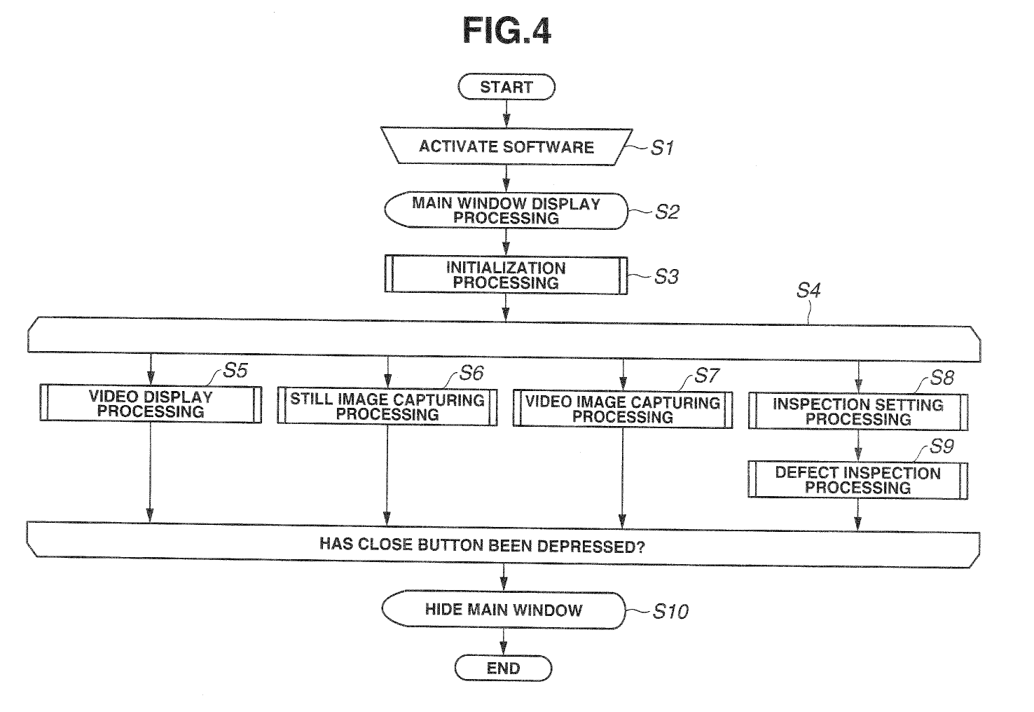

Here, a flow of operation of the defect inspection software is described with reference to FIG. 4. FIG. 4 is a flowchart for describing the flow of operation of the defect inspection software.

First, the user activates the defect inspection software (step S1). At this time, the CPU 34c reads the defect inspection software stored in the ROM 34b into the RAM 34a based on the activation instruction of the defect inspection software inputted through the remote controller 23, and starts operation according to the defect inspection software.

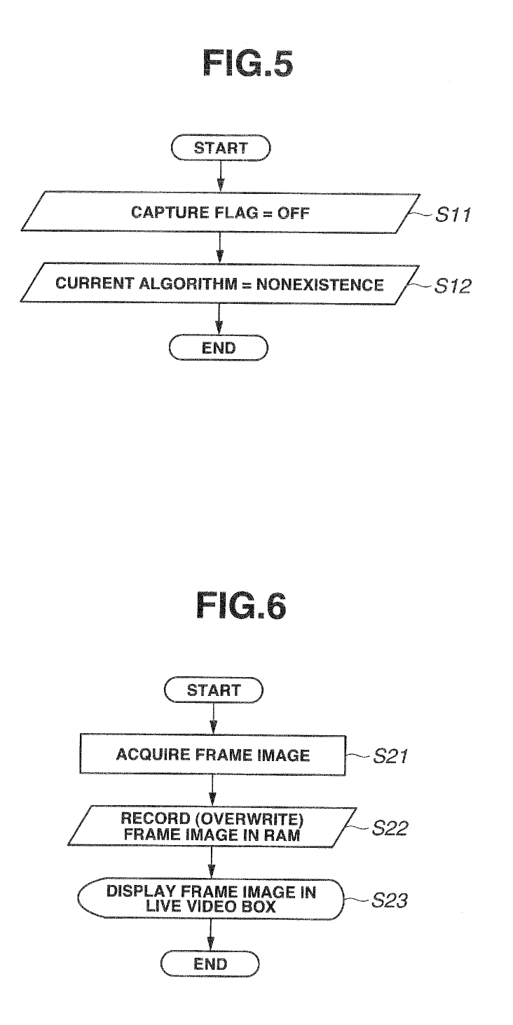

Next, the CPU 34c performs processing for displaying the main window 50 (step S2) and then performs initialization processing (step S3). The initialization processing includes setting processing of initial states of various GUIs in the main window 50 and setting processing of initial values of various data recorded in the RAM 34a. The initialization processing will be detailed with reference to FIG. 5 which will be described later.

Next, the CPU 34c performs repeating processing (step S4). When the close button 59 is depressed, the repeating processing is terminated, and the processing proceeds to step S10. The step S4 in which the repeating processing is performed includes five flows of step S5, step S6, step S7, step S8 and step S9. The processings in step S5, step S6, step S7, and step S8 are performed in parallel in an asynchronous manner. However, after the processing in the step S8 was performed, the processing in the step S9 is performed. Accordingly, similarly as the processing in the step S8, the processing in the step S9 is performed in parallel with the processings in the steps S5, S6, and S7 in an asynchronous manner.

In the step S5, the CPU 34c performs video displaying processing. The video displaying processing is the processing for displaying an endoscope video in the live video box 51. The video displaying processing will be detailed with reference to FIG. 6 which will be described later.

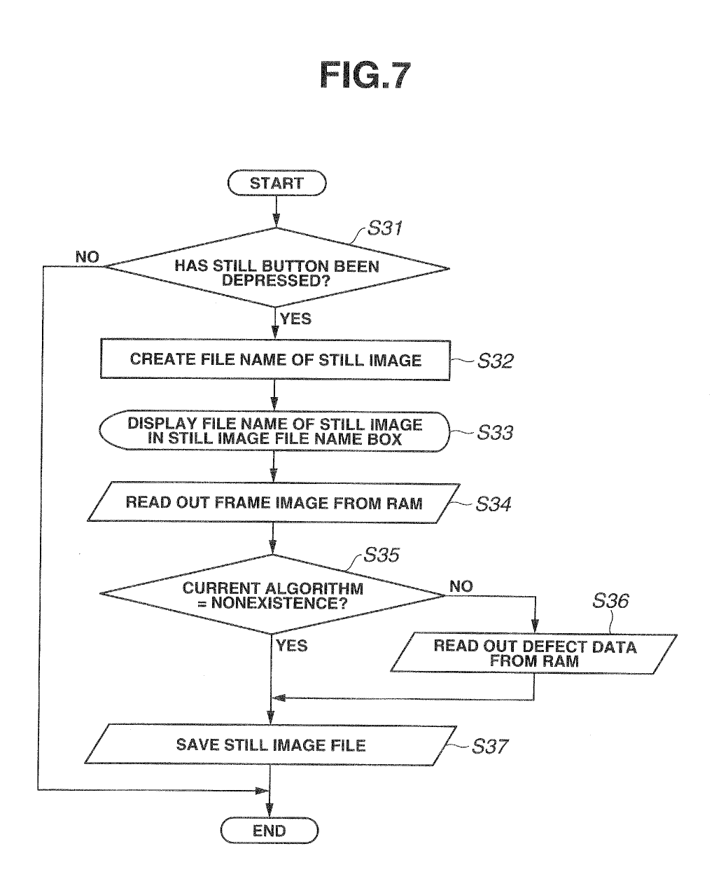

In the step S6, when the user depresses the still button 52, the CPU 34c performs still image capturing processing. The still image capturing processing is the processing of saving an image for one frame of the endoscope video in the CF card 40 as a still image file. The still image capturing processing will be detailed with reference to FIG. 7 which will be described later.

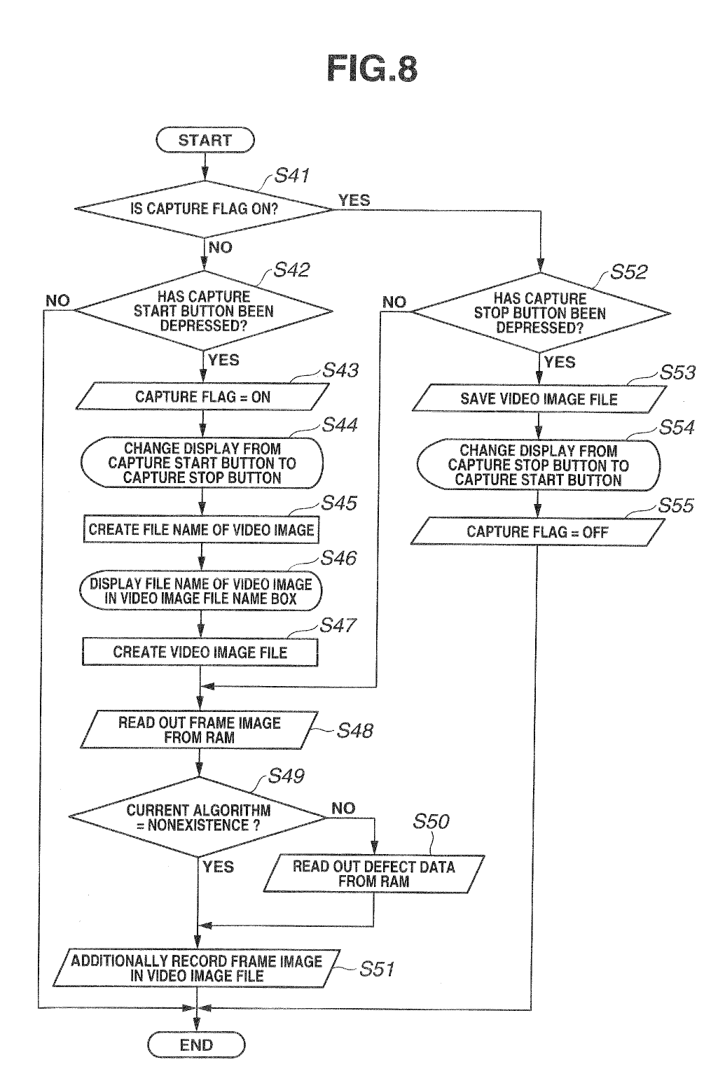

In the step S7, when the user depresses the capture start button 54, the CPU 34c performs the video image capturing processing. The video image capturing processing is the processing of saving the endoscope video in the CF card 40 as a video image file. The video image capturing processing will be detailed with reference to FIG. 8 which will be described later.

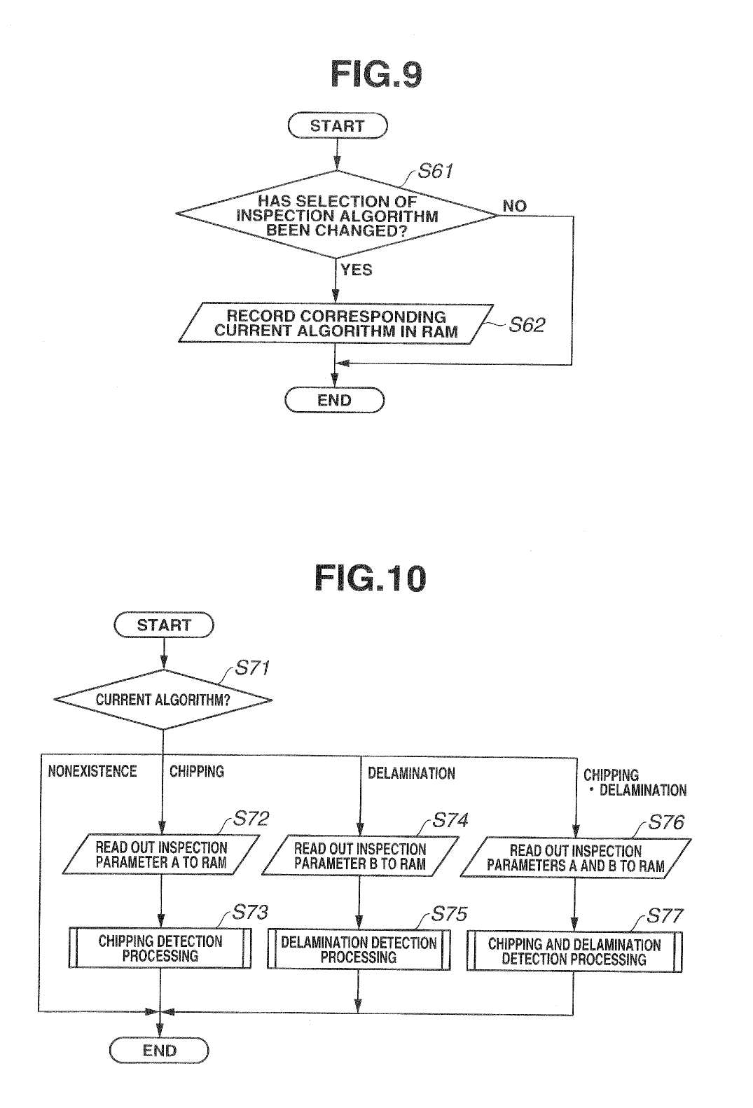

In addition, the CPU 34c performs inspection setting processing (step S8). The inspection setting processing is the processing of setting an inspection algorithm or an inspection parameter used in the defect inspection processing to be described later. The inspection setting processing will be detailed with reference to FIG. 9 which will be described later.

When the processing in the step S8 is performed, the CPU 34c performs the defect inspection processing (step S9). The defect inspection processing is the processing of performing defect inspection on the object by applying an inspection algorithm to the endoscope video. The defect inspection processing will be detailed with reference to FIG. 10 which will be described later.

When the close button 59 is depressed in the step S4, the CPU 34c hides the main window 50 (step S10) and then terminates the operation of the defect inspection software.

Next, the initialization processing in the step S3 will be described with reference to FIG. 5. FIG. 5 is a flowchart for describing the initialization processing in the step S3 in FIG. 4.

First, the CPU 34c records a capture flag as OFF in the RAM 34a (step S11). The capture flag is a flag indicating whether or not the capturing of video image is currently performed. The capture flag is recorded in the RAM 34a. The value which can be set by the capture flag is either ON or OFF.

Finally, the CPU 34c records the current algorithm as “nonexistence” in the RAM 34a (step S12) and terminates the processing. The current algorithm is the inspection algorithm which is currently executed (selected). The current algorithm is recorded in the RAM 34a. The values which can be defined by the current algorithm include four values of “nonexistence”, “chipping”, “delamination” and “chipping and delamination”.

Next, the video displaying processing in the step S5 will be described with reference to FIG. 6. FIG. 6 is a flowchart for describing the video displaying processing in the step S5 in FIG. 4.

First, the CPU 34c captures the image (image signal) for one frame from the image signal processing apparatus 31 as a frame image (step S21). Note that the image pickup device 30b generates an image pickup signal for one frame at the time point before the step S21, and the image signal processing apparatus 31 converts the image pickup signal into a video signal to generate the image for one frame.

Then, the CPU 34c records in the RAM 34a the frame image captured in the step S21 (step S22). The frame image recorded in the RAM 34a is overwritten every time the CPU 34c captures a frame image.

Finally, the CPU 34c performs processing for displaying the frame image captured in the step S21 in the live video box 51 (step S23) and terminates the processing.

Next, a flow of the still image capturing processing in the step S6 will be described with reference to FIG. 7. FIG. 7 is a flowchart for describing the flow of the still image capturing processing in step S6 in FIG. 4.

First, the CPU 34c determines whether or not the still button 52 has been depressed by the user (step S31). When it is determined that the still button 52 has been depressed (YES), the processing moves on to the step S32. When it is determined that the still button 52 has not been depressed (NO), the still image capturing processing is terminated.

Next, the CPU 34c creates a file name of the still image file (step S32). The file name represents the date and time at which the still button 52 was depressed. If the still button 52 was depressed at 14:52:34 on Oct. 9, 2009, for example, the file name is “20091009145234. jpg”. Note that the format of the still image file is not limited to the jpg format, and other format may be used.

Next, the CPU 34c displays the file name of the still image file, which was created in the step S32, in the still image file name box 53 (step S33).

Next, the CPU 34c reads out the frame image recorded in the RAM 34a in the above-described step S22 (step S34).

Then, the CPU 34c checks whether or not the current algorithm recorded in the RAM 34a is “nonexistence” (step S35). When the current algorithm is “nonexistence” (YES), the processing moves on to step S37. When the current algorithm is other than “nonexistence” (NO), the processing moves on to step S36.

In the step S36, the CPU 34c reads out the defect data recorded in the RAM 34a. The defect data is the data including defect information detected from the image of the object. The defect data will be detailed later.

Finally, the CPU 34c saves the frame image as a still image file in the CF card 40 (step S37). If the defect data has been read out in the step S36, the defect data is recorded as a part of header information of the still image file. When the processing in the step S37 is terminated, the still image capturing processing is terminated.

Next, the video image capturing processing in the step S7 will be described with reference to FIG. 8. FIG. 8 is a flowchart for describing the video image capturing processing in the step S7 in FIG. 4.

First, the CPU 34c determines whether or not the capture flag recorded in the RAM 34a is ON (step S41). When it is determined that the capture flag is ON (YES), the processing moves on to step S52. When it is determined that the capture flag is OFF (NO), the processing moves on to step S42.

When it is determined that the capture flag is OFF, the CPU 34c determines whether or not the capture start button 54 has been depressed by the user (step S42). When it is determined that the capture start button 54 has been depressed (YES), the processing moves on to step S43. When it is determined that the capture start button 54 has not been depressed (NO), the video image capturing processing is terminated.

When it is determined that the capture start button 54 has been depressed, the CPU 34c records the capture flag as ON in the RAM 34a (step S43).

Next, the CPU 34c changes the display of the capture start button 54 from “capture start” to “capture stop” (step S44).

Then, the CPU 34c creates the file name of the video image file (step S45). The file name represents the date and time at which the capture start button 54 was depressed. If the capture start button 54 was depressed at 14:52:34 on Oct. 9, 2009, for example, the file name is “20091009145234. avi”. Note that the format of the video image file is not limited to the avi format, and other format may be used.

Next, the CPU 34c displays the file name of the video image file, which was created in the step S45, in the video image file name box 55 (step S46).

Subsequently, the CPU 34c creates a video image file and records the video image file in the RAM 34a (step S47). However, the video image file created at this stage is a file in the initial state and a video has not been recorded yet in the file. In step S51 to be described later, frame images are recorded sequentially and additionally in the video image file.

Next, the CPU 34c reads out the frame image recorded in the RAM 34a (step S48).

Then, the CPU 34c checks whether or not the current algorithm recorded in the RAM 34a is “nonexistence” (step S49). When the current algorithm is “nonexistence” (YES), the processing moves on to step S51. When the current algorithm is other than “nonexistence” (NO), the processing moves on to step S50.

In the step S50, the CPU 34c reads out the defect data recorded in the RAM 34a.

Next, the CPU 34c additionally records the read-out frame image in the video image file recorded in the RAM 34a (step S51). If the defect data was read out in the step S50, the defect data is recorded as a part of the header information of the video image file. When the processing in the step S51 is terminated, the video image capturing processing is terminated.

On the other hand, when it is determined that the capture flag is ON in the step S41, the CPU 34c determines whether or not the capture stop button 54 has been depressed by the user (step S52). When it is determined that the capture stop button 54 has been depressed (YES), the processing moves on to the step S53. When it is determined that the capture stop button 54 has not been depressed (NO), the processing moves on to step S48.

When it is determined that the capture stop button 54 has been depressed, the CPU 34c saves the video image file recorded in the RAM 34a in the CF card 40 (step S53). The file name of the video image file to be saved at this time is the file name created in the step S45.

Next, the CPU 34c changes the display of the capture stop button 54 from “capture stop” to “capture start” (step S54).

Finally, the CPU 34c records the capture flag as OFF in the RAM 34a (step S55). When the processing in the step S55 is terminated, the video image capturing processing is terminated.

Next, the inspection setting processing in the step S8 will be described with reference to FIG. 9. FIG. 9 is a flowchart for describing the inspection setting processing in the step S8 in FIG. 4.

First, the CPU 34c determines whether or not the selection state of the inspection algorithm selection check box 58 has been changed by the user (step S61). When it is determined that the selection state of the inspection algorithm selection check box 58 has been changed (YES), the processing moves on to step S62. When it is determined that the selection state of the inspection algorithm selection check box 58 has not been changed (NO), the inspection setting processing is terminated.

When it is determined that the selection state of the inspection algorithm selection check box 58 has been changed, the CPU 34c changes the corresponding current algorithm based on the selection state of the inspection algorithm selection check box 58, and records the changed current algorithm in the RAM 34a (step S62). When the processing in the step S62 is terminated, the inspection setting processing is terminated.

Next, the defect inspection processing in the step S9 will be described with reference to FIG. 10. FIG. 10 is a flowchart for describing the defect inspection processing in the step S9 in FIG. 4.

First, the CPU 34c checks the content of the current algorithm recorded in the RAM 34a (step S71). When the current algorithm is “nonexistence”, the defect inspection processing is terminated. When the current algorithm is “chipping”, the processing moves on to step S72. When the current algorithm is “delamination”, the processing moves on to step S74. When the current algorithm is “chipping and delamination”, the processing moves on to step S76.

Here, description will be made on the processing when the current algorithm is “chipping” in the step S71.

The CPU 34c reads out to the RAM 34a an inspection parameter A stored in the ROM 34b, as the inspection parameter for performing chipping detection (step S72). The inspection parameter is the image processing parameter for performing defect inspection, and is used in the chipping detection processing, delamination detection processing, chipping and delamination detection processing which will be described later.

Next, the CPU 34c performs the chipping detection processing (step S73). The chipping detection processing is to perform image processing based on the inspection parameter A read out to the RAM 34a, and thereby detecting the chipping part of the object. The chipping detection processing will be detailed later. When the chipping detection processing in the step S73 is terminated, the defect inspection processing is terminated.

Here, description will be made on the processing performed when the current algorithm is “delamination” in the step S71.

The CPU 34c reads out to the RAM 34a an inspection parameter B stored in the ROM 34b, as the inspection parameter for performing delamination detection (step S74). Note that the inspection parameter B is the inspection parameter for performing delamination detection.

Next, the CPU 34c performs delamination detection processing (step S75). The delamination detection processing is to perform image processing based on the inspection parameter B read out to the RAM 34a, and thereby detecting the delamination part of the object. When the delamination detection processing in the step S75 is terminated, the defect inspection processing is terminated.

Here, description will be made on the processing performed when the current algorithm is “chipping and delamination” in the step S71.

The CPU 34c reads out to the RAM 34a both the inspection parameter A and the inspection parameter B stored in the ROM 34b, as the inspection parameters for performing chipping and delamination detection (step S76).

Next, the CPU 34c performs the chipping and delamination detection processing (step S77). The chipping and delamination detection processing is processing is to perform image processing based on both of the inspection parameters A and B read out to the RAM 34a, and thereby detecting both the chipping part and the delamination part of the object. When the chipping and delamination detection processing in the step S77 is terminated, the defect inspection processing is terminated.

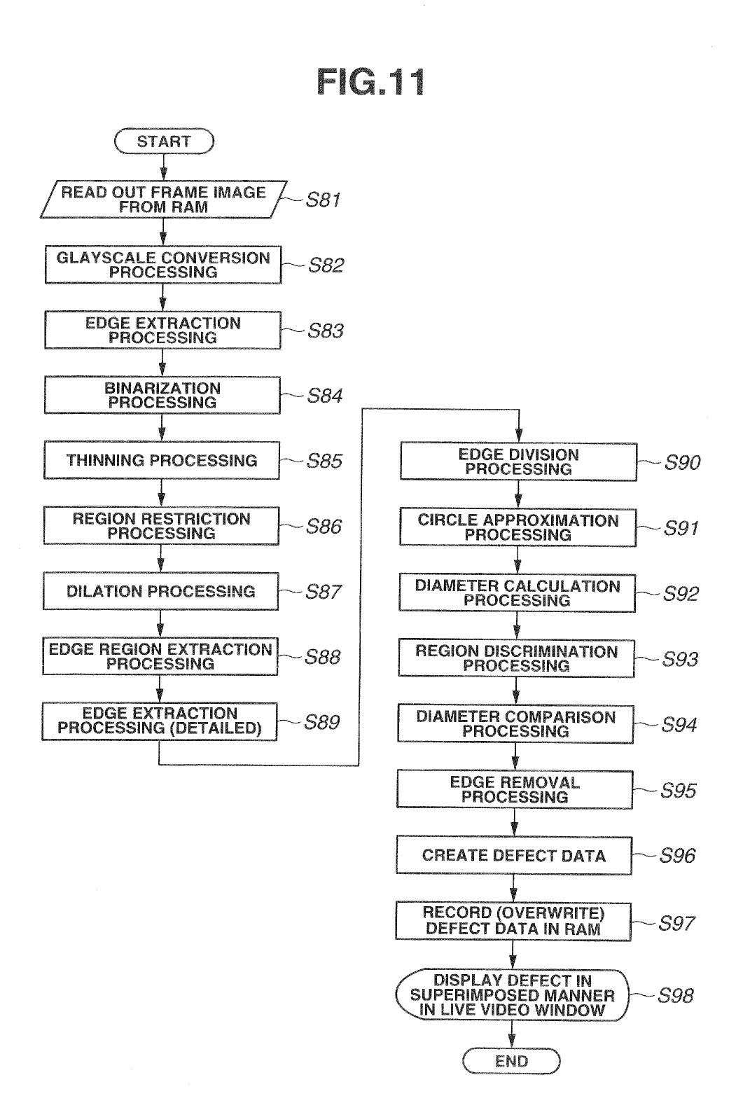

Next, the chipping detection processing in the step S73 is described with reference to FIG. 11. FIG. 11 is a flowchart for describing the chipping detection processing.

The chipping detection processing shown in FIG. 11 is repeatedly performed on all the frames or a part of the frames of the captured video image.

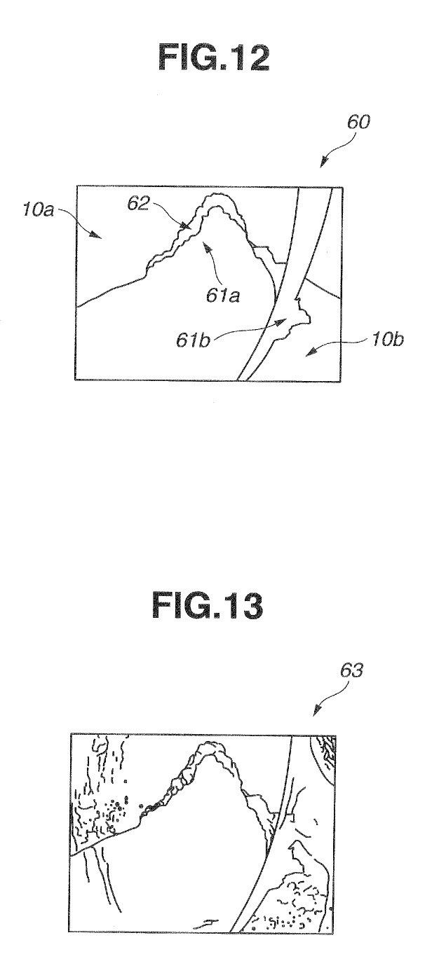

First, the CPU 34c reads out the frame image recorded in the RAM 34a (step S81). FIG. 12 is a view of a read-out frame image 60. The frame image 60 is an endoscope image in which two turbine blades 10 are captured. Here, one of these two turbine blades is referred to as a turbine blade 10a, and the other is referred to as a turbine blade 10b. The turbine blade 10a includes a chipping part 61a and a delamination part 62, and the turbine blade 10b includes a chipping part 61b.

Next, the CPU 34c converts the read-out frame image into a grayscale image (step S82). Luminance value Y for each pixel in the grayscale image is calculated based on the RGB luminance value for each pixel in the frame image as a color image by using Equation 1 below.

Y=0.299×R+0.587×G+0.114×B (Equation 1)

Next, the CPU 34c converts the grayscale image into an edge image using a Kirsch filter and the like (step S83). Hereinafter, the edge image obtained in this step is referred to as an edge image A63. FIG. 13 is a view of the edge image A63 converted from the grayscale image. In the edge image A63 in FIG. 13, an edge which is not included in the frame image 60 in FIG. 12 is extracted. This is because the frame image 60 is a color image and the edge is extracted after converting the frame image 60 into the grayscale image, and the edge which is not expressed in the frame image 60 in FIG. 12 is extracted.

The Kirsch filter is a kind of edge extraction filter which is called a first order differential filter, and is characterized by being capable of emphasizing the edge part more than other first order differential filters. The image to be inputted to the Kirsch filter is a grayscale image (8 bit, for example) and the image to be outputted from the Kirsch filter is also a grayscale image.

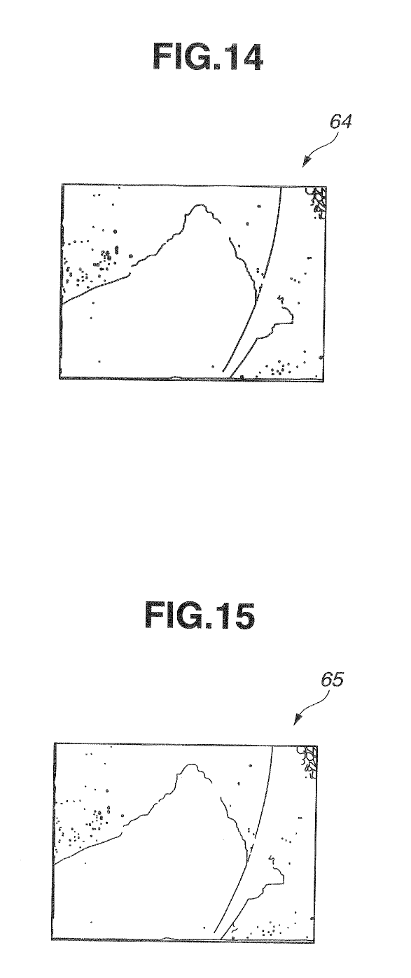

Next, the CPU 34c performs binarization processing on the edge image A63 to convert the edge image A63 into a binary image (step S84). In the processing in the step S84, based on the luminance range (a first condition) included in the inspection parameter (the inspection parameter A in this case) read out to the RAM 34a, the binarization processing is performed such that, among the pixels constituting the edge image A63, the pixels within the luminance range are set as white pixels, and the pixels outside the luminance range are set as black pixels. Hereinafter, the binary image obtained in this step is referred to as a binary image 64. FIG. 14 is a view of a binary image 64 converted from the edge image A63. In the binary image 64, the edge of the delamination part 62 is removed. This is because the edge of the delamination part 62 is an edge formed on the blade surface, and is an edge weaker than the edges of the chipping parts 61a and 61b. The inspection parameter A includes the luminance range from which the edge of the delamination part 62 is removed in the binarization processing.

Next, the CPU 34c performs thinning processing on the binary image 64 to convert the binary image 64 into a thin line image (step S85). Hereinafter, the thin line image obtained in this step is referred to as a thin line image A65. FIG. 15 is a view of the thin line image A65 converted from the binary image 64.

Next, the CPU 34c performs region restriction processing on the thin line image A65 to convert the thin line image A65 into a thin line image whose region is restricted (step S86). The region restriction processing is processing of removing thin lines in a part of regions in the image, i.e., the peripheral region of the image in this case, to exclude the thin lines in the region from the processing target. Hereinafter, the thin line image subjected to the region restriction as described above is referred to as a thin line image B66.

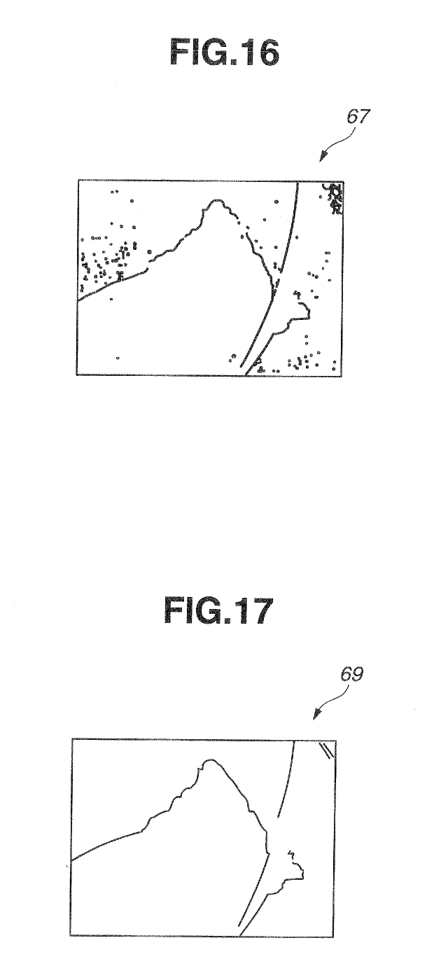

Next, the CPU 34c performs dilation processing on the thin line image B66 to convert the thin line image B66 into a dilation image (step S87). Hereinafter, the dilation image obtained in this step is referred to as a dilation image 67. FIG. 16 is a view of the dilation image 67 converted from the thin line image B66.

Next, the CPU 34c performs edge region extraction processing to create an image by taking out only the part located in the edge region of the dilation image 67 from the grayscale image (step S88). Hereinafter, the image obtained in this step is referred to as an edge region image 68.

Next, the CPU 34c extracts from the edge region image 68 an edge whose lines are thinned with high accuracy using a Canny filter, to generate an edge image (step S89). At this time, the edges whose lengths are short are not extracted. Hereinafter, the edge image obtained in this step is referred to as an edge image B69. FIG. 17 is a view of the edge image B69 generated from the edge region image 68.

The Canny filter extracts both the strong edge and the weak edge using two thresholds. The Canny filter allows the weak edge to be extracted only when the weak edge is connected to the strong edge. The Canny filter is more highly accurate than other filters and is characterized by being capable of selecting the edge to be extracted. The image to be inputted to the Canny filter is a grayscale image and the image to be outputted from the Canny filter is a line-thinned binary image.

The brief summary of the above-described steps S81 to S89 is as follows. The CPU 34c first roughly extracts the edge of the image in the step S83, and in the steps S84 to S88, extracts the region for performing detailed edge extraction based on the roughly extracted edge. Finally in the step S89, the CPU 34c performs detailed edge extraction. The steps S82 to S89 constitute an edge detection section (a feature detection section) for detecting the edge (a first feature portion) of the frame image as the image data read out in the step S81.

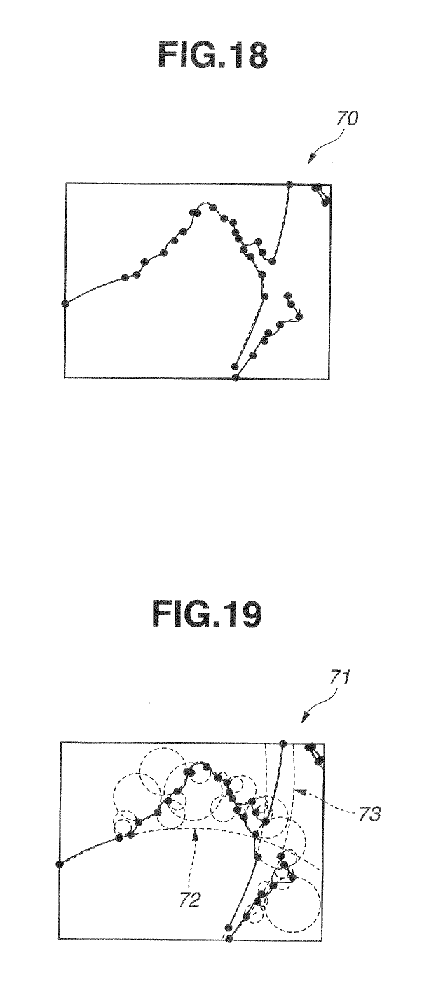

Next, the CPU 34c divides the edge in the edge image B69 by edge division processing to generate an image of divided edge (step S90). At this time, the edge is divided at points having steep direction changes on the edge. The points having the steep direction changes are called division points. The edge divided at the division points, in other words, the edge connecting two neighboring division points, is called a divided edge. However, the divided edge after the division has to meet a condition that the length thereof is equal to or longer than a predetermined length. Hereinafter, the image generated in this step is referred to as a divided edge image 70. FIG. 18 is a view of the divided edge image 70 generated from the edge image B69. The points indicated by black filled circles in the divided edge image 70 are the division points.

Next, the CPU 34c performs circle approximation processing to approximate a circle to each of the divided edges in the divided edge image 70 (step S91). At this time, the divided edges and the approximated circles are associated with each other, respectively, to be recorded in the RAM 34a. Hereinafter, the image on which the circle approximation has been performed is referred to as a circle approximation image 71. FIG. 19 is a view of the circle approximation image 71 in which a circle is approximated to each of the divided edges in the divided edge image 70. As shown in FIG. 19, by the processing in the step S91, the parts where the turbine blades 10a and 10b are not chipped are shown by straight lines or gentle curves and assigned with circles 72 and 73 having large diameters. On the other hand, the parts where the turbine blades 10a and 10b are chipped are not shown by straight lines or gentle curves and assigned with circles having small diameters.

Next, the CPU 34c calculates the diameters of the respective circles approximated to the divided edges in step S91 (step S92).

Next, the CPU 34c discriminates a plurality of regions, i.e., the two turbine blades 10a and 10b in the present embodiment according to the diameters of the respective circles calculated in the step S91 (step S93). The CPU 34c detects the circle having the largest diameter and the circle having the second largest diameter of the diameters of the respective circles calculated in step S92, to determine the first and the second turbine blades 10a, 10b. In other words, the CPU 34c detects the divided edge having the smallest curvature and the divided edge having the second smallest curvature, to discriminate the first and the second turbine blades 10a, 10b. The processing in the step S93 constitutes a blade discrimination section (a feature discrimination section) which discriminates the first turbine blade 10a (a first object) and the second turbine blade 10b (a second object) based on the size of the curvature.

When the circle 72 in FIG. 19 has the largest diameter and the circle 73 has the second largest diameter, for example, the divided edge with which the circle 72 is associated and a divided edge directly or indirectly connected to the divided edge with which the circle 72 is associated are determined as the first turbine blade 10a, and the divided edge with which the circle 73 is associated and a divided edge directly or indirectly connected to the divided edge with which the circle 73 is associated are determined as the second turbine blade 10b. Note that the two turbine blades 10a and 10b are discriminated in the step S93. However, three or more turbine blades may be discriminated.

Next, the CPU 34c compares each of the diameters of the circles calculated in the step S92 with a diameter threshold recorded in the RAM 34a, to extract the circles having diameters larger than the diameter threshold (step S94). The diameter threshold is included as a part of the inspection parameter A.

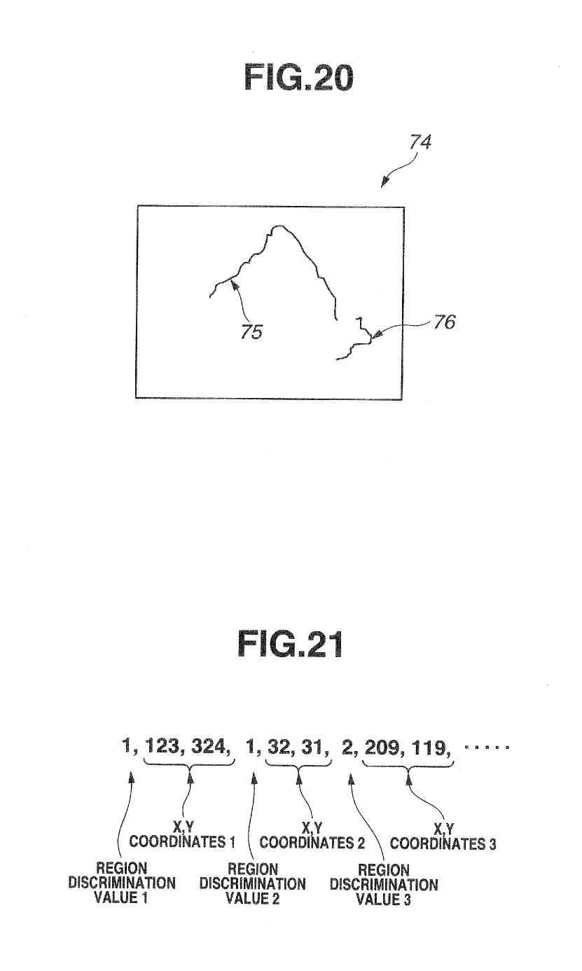

Subsequently, the CPU 34c removes the divided edges associated with the circles having diameters larger than the diameter threshold which were extracted in the step S94 (step S95). Hereinafter, the edge image obtained in this step is referred to as an edge image C74. FIG. 20 is a view of the edge image C74 generated by removing predetermined divided edges from the divided edge image 70. As shown in FIG. 20, the divided edges associated with the circles having large diameters, i.e., the circle 72 and the circle 73 are removed by the processing in step S95. That is, the edges of the parts where the turbine blades 10a and 10b are not chipped are removed. As a result, only edges 75 and 76 of the chipping parts 61a and 62b (information indicative of the first defect portion) are detected by the processing performed by the CPU 34c as the defect detection section.

Next, the CPU 34c creates defect data based on the edge image C74 created in the step S95 (step S96). The defect data is a collection of data of coordinate numerical values of the pixels constituting the edges in the edge image C74. FIG. 21 is an example of the defect data in which numerical values data of the region discrimination values, the X-coordinates and the Y-coordinates of the respective pixels constituting the edges are alternately aligned. In the present embodiment, if the pixel is located in a region 1, the region discrimination value of the pixel is defined as “1”, and if the pixel is located in a region 2, the region discrimination value of the pixel is defined as “2”.

Then, the CPU 34c records the defect data created in the step S96 in the RAM 34a (step S97). The defect data recorded in the RAM 34a is overwritten every time the CPU 34c creates defect data.

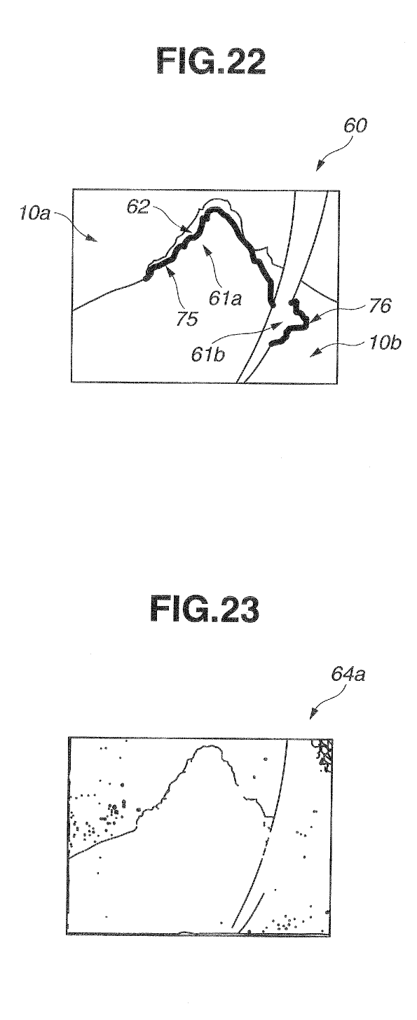

Finally, the CPU 34c performs processing for displaying the pixels constituting the edges superimposed on the endoscope video in the live video box 51 based on the defect data created in the step S96 (step S98), to terminate the defect inspection processing. FIG. 22 is a view showing that defect data (chipping) is superimposed on an endoscope video. When the CPU 34c displays the defect data superimposed on the endoscope video in the live video box 51, it is preferable to thickly dilate the edges and display the edges in a color different from the color of the turbine blades 10 so that the user can clearly observe the chipping parts 61a and 61b.

Furthermore, it is preferable that the CPU 34c displays the chipping parts 61a, 61b in different colors, respectively, so that the user can observe the chipping parts are located at which of the first and the second turbine blades 10a, 10b, based on the region discrimination values in the defect data.

According to such defect inspection processing, the chipping parts on the plurality of turbine blades 10, that is, the chipping part 61a on the first turbine blade 10a and the chipping part 61b on the second turbine blade 10b are displayed in different colors. Therefore, the user can easily identify the chipping parts 61a and 61b on the plurality of turbine blades 10a and 10b.

In addition, according to such defect inspection processing, chipping detection is performed on a plurality of continuous frame images, that is, a video image. Therefore, even if the chipping detection was not successful in a certain frame image, for example, the chipping detection is sometimes successful in the next frame image. That is, in a still image, if the chipping detection is not successful, the user cannot identify chipping. However, in a video image, both the case where the chipping detection is successful and the case where the chipping detection is not successful mixedly exist. Accordingly, if looking at the video image for the entire period during which the chipping detection is performed, the user can identify the detected chipping. In addition, in a video image, it is more preferable that the frame image in which the chipping detection is successful and the frame image in which the chipping detection is not successful are alternately displayed than the case where frame images in which the chipping detection is successful are constantly displayed. It is because such a display configuration is more useful for calling the user's attention. In such a display configuration, display and non-display of the chipping are repeated on a display screen. Therefore, such a display configuration is allowed to serve also as an alarm for the user.

Now, description is made on the delamination detection processing in the step S75. The delamination detection processing is described with reference to the flowchart in FIG. 11, similarly to the chipping detection processing in the step S73. However, only the procedures different from those in the chipping detection processing in the step S73 are described here.

FIG. 23 illustrates the binary image 64a subjected to the binarization processing in the step S84. In the processing in the step S84, based on the luminance range (a second condition) included in the inspection parameter (inspection parameter B in this case) read out to the RAM 34a, the binarization processing is performed such that, among the pixels constituting the edge image A63, the pixels within the luminance range are set as white pixels and the pixels outside the luminance range are set as black pixels.

In the binary image 64a, the edges of the chipping parts 61a and 61b are removed. This is because the edges of the chipping parts 61a and 61b are the edges formed on the blade ends and are the edges stronger than the edge of the delamination part 62. The inspection parameter B includes the luminance range from which the edges of the chipping parts 61a and 61b are removed in the binarization processing.

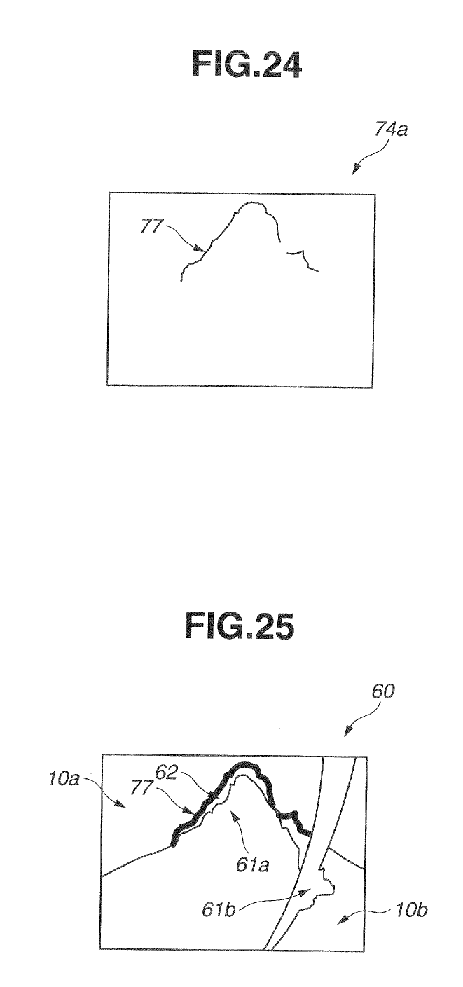

FIG. 24 illustrates an edge image C74a subjected to edge removal processing in step S95. Only an edge 77 of the delamination part 62 (information indicative of the second defect portion) is detected by the processing in step S95.

FIG. 25 is a view showing that the defect data (delamination) is displayed superimposed on the endoscope video in the step S98.

Now, description is made on the chipping and delamination detection processing in the step S77. The chipping and delamination detection processing is described with reference to the flowchart in FIG. 11 similarly to the chipping detection processing in the step S73. However, only the procedures different from those in the chipping detection processing in the step S73 are described here.

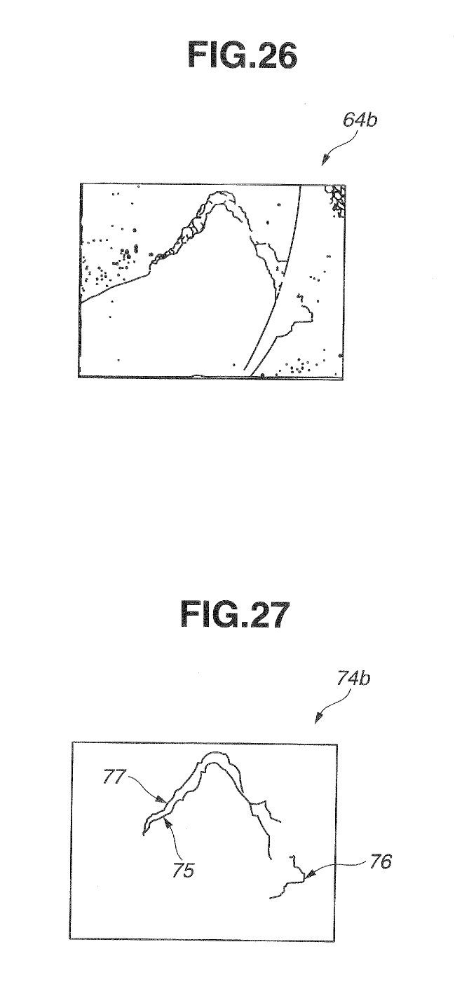

FIG. 26 illustrates the binary image 64b subjected to the binarization processing in the step S84. In the step S84, the binarization processing is performed based on the luminance ranges included in the inspection parameters (both the inspection parameters A and B in this case) read out to the RAM 34a. Therefore, both the edges of the chipping parts 61a, 61b and the edge of the delamination part 62 are extracted.

FIG. 27 illustrates the edge image C74b subjected to the edge removal processing in the step S95. The edges 75, 76 of the chipping part 61a and 61b and the edge 77 of the delamination part 62 are detected by the processing in the step S95.

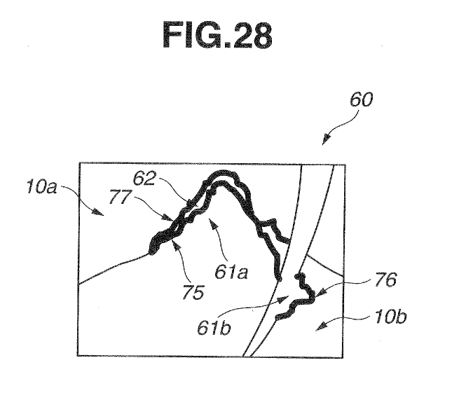

FIG. 28 is a view showing that defect data (chipping and delamination) is superimposed on the endoscope video in step S98. When the CPU 34c displays the defect data superimposed on the endoscope video in the live video box 51, it is preferable that the chipping parts 61a, 61b and the delamination part 62 are displayed in different colors, respectively, so that the user can observe the chipping parts 61a, 61b, and the delamination part 62 distinctly from one another.

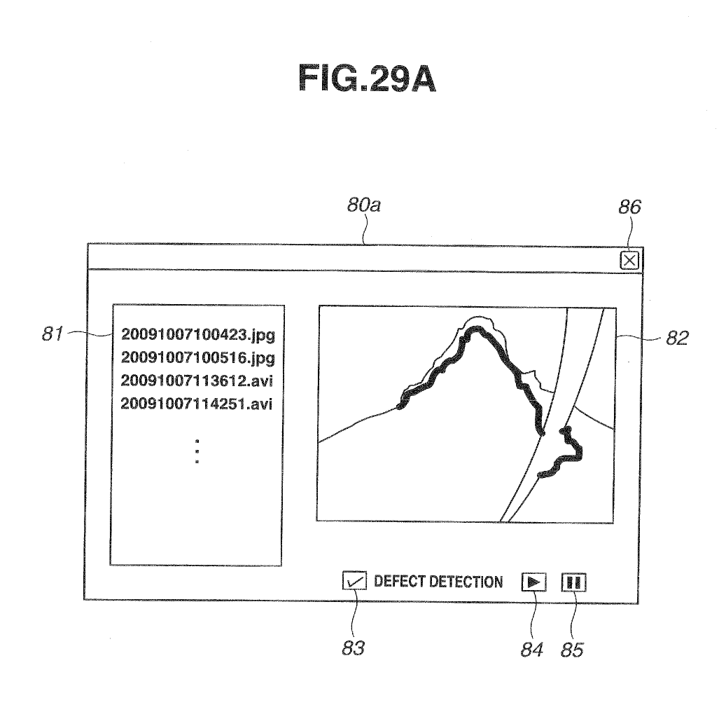

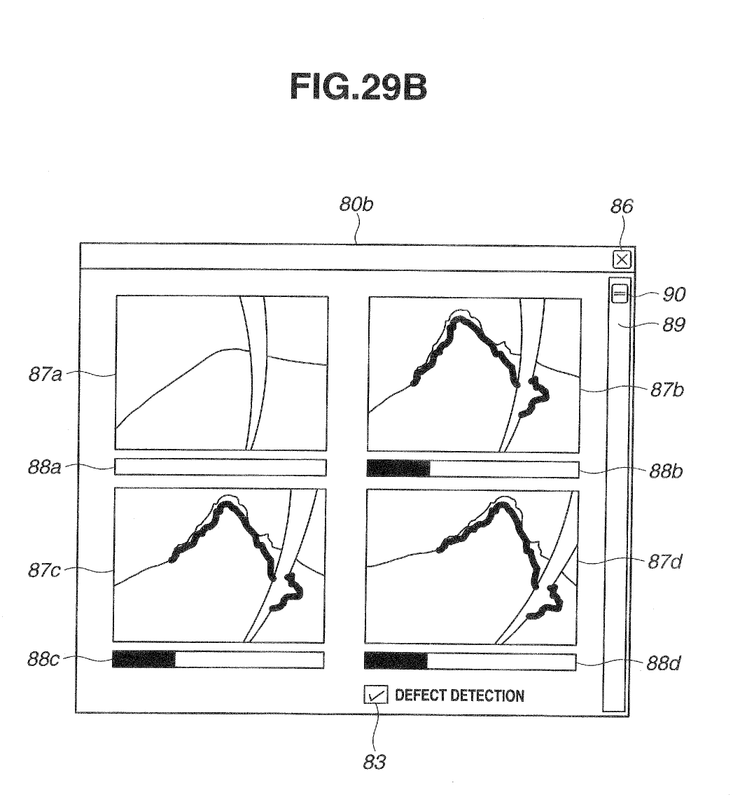

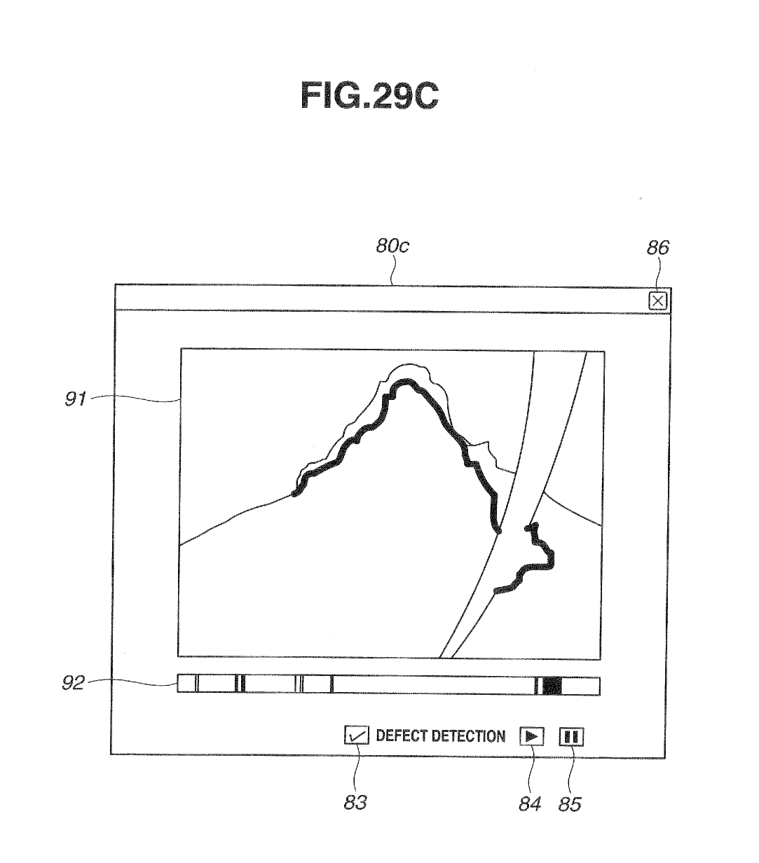

Here, description is made on the browse window to be displayed when the browse button 56 in FIG. 3 is depressed. FIG. 29A shows the browse window to be displayed when the browse button 56 is depressed.

A browse window 80a includes a file name list box 81, a browse box 82, a defect detection check button 83, a play button 84, a stop button 85, and a close button (“x” button) 86.

The file name list box 81 is a box for displaying, as a list, the file names of the still image files saved in the CF card 40 or the file names of the video image files saved in the CF card 40.

The browse box 82 is a box for displaying the image in the still image file selected in the file name list box 81 or the video image in the video image file selected in the file name list box 81.

The defect detection check button 83 is a button for displaying the defect data superimposed on an endoscope video. In the case where the defect detection check button 83 is checked, when the still image file or the video image file is read, if the defect data is included in the header of the file, the defect data is read as accompanying information.

The play button 84 is a button for playing the video image file. The stop button 85 is a button for stopping the video image file which is being displayed.

The close button 86 is a button for closing the browse window 80a to return to the main window 50. Note that the browse window 80a may be configured as shown in FIG. 29B or FIG. 29C.

FIGS. 29B and 29C each shows another example of the browse window to be displayed when the browse button 56 is depressed. In FIGS. 29B and 29C, the same components as those in FIG. 29A are attached with the same reference numerals and descriptions thereof will be omitted.

The browse window 80b shown in FIG. 29B is a browse window for displaying the endoscope images in the still image files as thumbnails. The browse window 80b includes four thumbnail image display boxes 87a to 87d, defect amount display bars 88a to 88d, a scroll bar 89, and a scroll box 90.

Endoscope images are displayed in the order of earlier capturing date and time, for example, in the thumbnail image display boxes 87a to 87d.

The defect amount display bars 88a to 88d respectively display the defect amounts included in the endoscope images displayed in the thumbnail image display boxes 87a to 87d. The defect amount means the number of defect data (coordinate data) read as accompanying information of the still image files. The longer the bars displayed in the defect amount display bars 88a to 88d, the larger the defect amounts detected in the still image files.

The scroll bar 89 is a bar for scrolling the display region. The scroll box 90 disposed on the scroll bar 89 is a box for indicating the current scroll position.

The user operates the scroll box 90 on the scroll bar 89, thereby capable of displaying thumbnail images captured after the thumbnail image displayed in the thumbnail image display box 87d in the browse window 80b.

Since the image files are displayed in the order of earlier capturing date and time, there is no need for the user to sequentially select the file name of the still image file displayed in the file name list box 81 in FIG. 29A and can easily identify which still image file saves the still image including the defect data.

Next, the browse window 80c shown in FIG. 29C is a browse window for displaying the endoscope video in the video image file. The browse window 80c includes a video image play box 91 and a defect amount display bar 92.

The video image play box 91 is a box for displaying the endoscope video in the video image file selected by the user.

The defect amount display bar 92 is a bar for displaying the time zone in which the defect data is included in the video image file. The left end of the defect amount display bar 92, when viewed facing FIG. 29C, indicates the capturing start time and the right end, when viewed facing FIG. 29C, indicates the capturing end time, and the time zone in which the defect data is included is filled with a color. In this case, the color filling the defect amount display bar 92 may be changed depending on the defect amount, that is, the amount of defect data included in the video image file.

The user can easily identify which time zone in the video image file includes a large amount of defect, by checking the defect amount display bar 92.

The browse window 80c is an example in the case where one video image file is played. However, the browse window 80c may have the similar configuration as the browse window 80b in FIG. 29B so that a plurality of video image files can be played at the same time.

As described above, the endoscope apparatus 3 of the present embodiment enables the existence or nonexistence, the amount, and the size of the defect on the blade to be easily recognized, and also enables a plurality of defects existing on a plurality of blades to be easily recognized.

### MODIFIED EXAMPLE

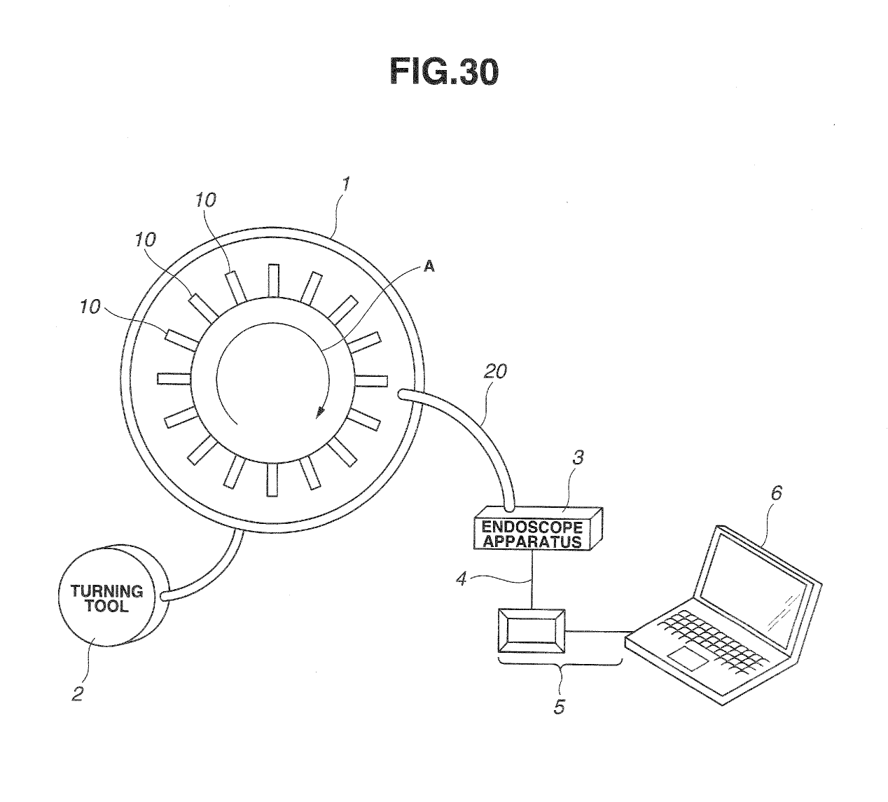

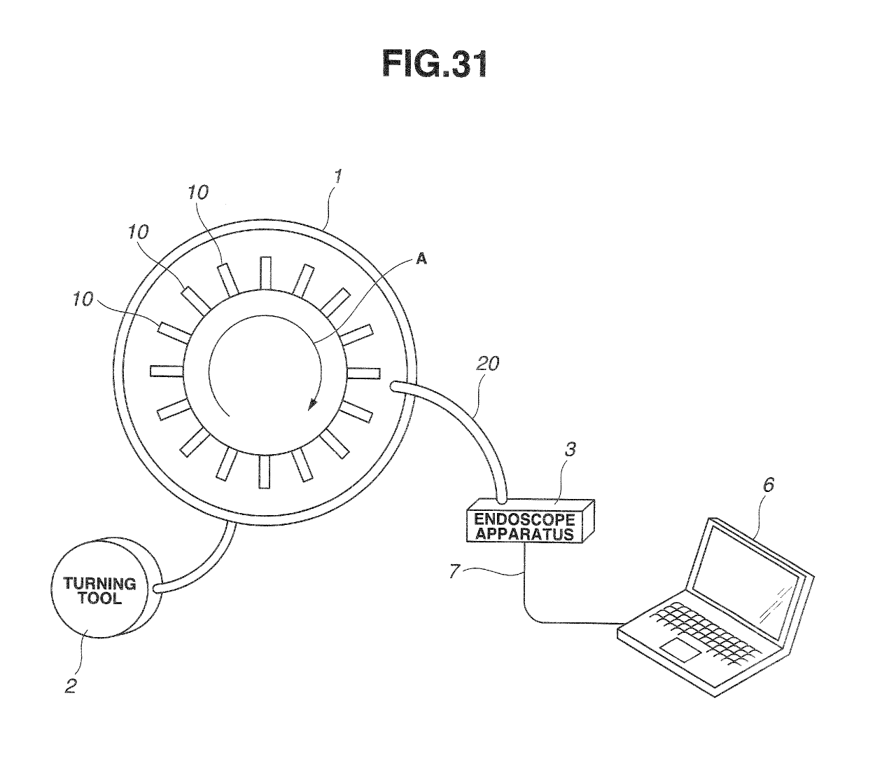

As a modified example of the configuration of the blade inspection system according to the above-described embodiment, the blade inspection system may have configurations as shown in FIGS. 30 and 31. FIG. 30 and FIG. 31 are views showing configurations of the blade inspection system according to the modified example of the present embodiment. As shown in FIG. 30, in the present modified example, a video terminal cable 4 and a video capture card 5 are connected to the endoscope apparatus 3, thereby allowing the video captured by the endoscope apparatus 3 to be captured also in a personal computer (PC) 6. The PC 6 is illustrated as a laptop in FIG. 30, but may be a desktop personal computer and the like. The PC 6 stores defect inspection software for recording the images of the turbine blades 10 picked up at a desired angle. The operation of the defect inspection software is the same as that in the above-described embodiment.

Furthermore, the video terminal cable 4 and the video capture card 5 are used for capturing a video into the PC 6 in FIG. 30. However, a LAN cable 7 may be used as shown in FIG. 31. The endoscope apparatus 3 includes a LAN OF 34d for allowing the captured video to be streamed on a LAN network. It is possible to cause the PC 6 to capture the video through the LAN cable 7.

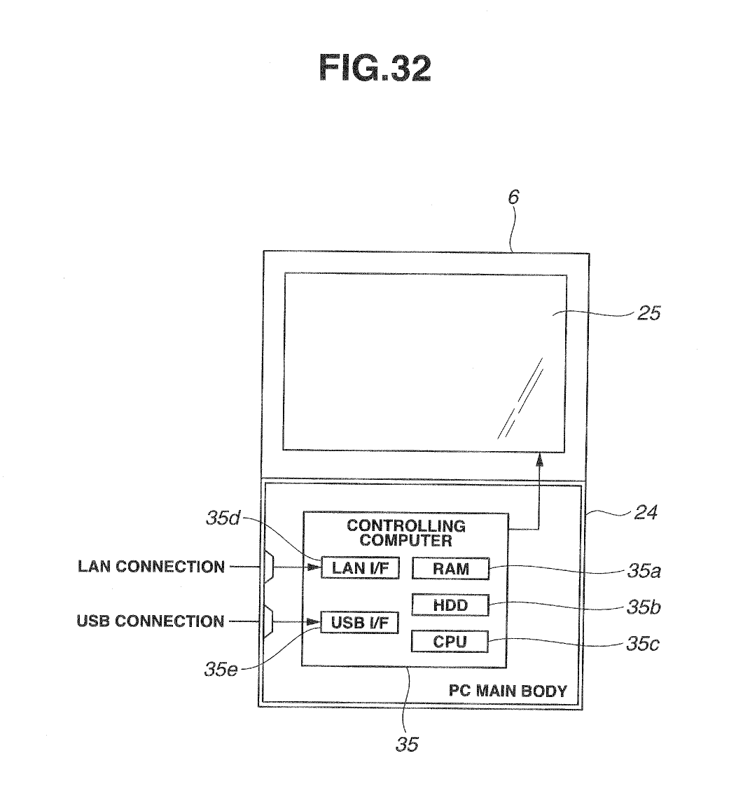

FIG. 32 is a block diagram for describing a configuration example of the PC 6. The PC 6 includes a PC main body 24 and a monitor 25. The PC main body 24 incorporates a controlling computer 35. The controlling computer 35 includes a RAM 35a, an HDD (hard disk drive) 35b, a CPU 35c, and LAN I/F 35d and a USB I/F 35e as external interfaces. The controlling computer 35 is connected to the monitor 25, and video information, a screen of the software, and the like are displayed on the monitor 25.

The RAM 35a is used for temporarily stores data such as image information and the like required for software operation. A series of software is stored in the HDD 35b in order to control the endoscope apparatus, and the defect inspection software is also stored in the HDD 35b. In addition, in the present modified example, a saving holder for saving the images of the turbine blades 10 is set in the HDD 35b. The CPU 35c performs various arithmetic operations for various controls by using the data stored in the RAM 35a, according to an instruction code from the software stored in the HDD 35b.

The LAN I/F 35d is an interface for connecting the endoscope apparatus 3 and the PC 6 through the LAN cable 7, thereby enabling the video information outputted from the endoscope apparatus 3 through the LAN cable to be inputted into the PC 6. The USB I/F 35e is an interface for connecting the endoscope apparatus 3 and the PC 6 through the video capture card 5, thereby enabling the video information outputted from the endoscope apparatus 3 as analog video to be inputted to the PC 6.

According to the present modified example, the same effects as those in the above-described embodiment can be obtained. Specifically, the present modified example is effective in the case where the performance of the endoscope apparatus is inferior to that of the PC and operation speed and the like of the endoscope apparatus are not sufficient.

Note that the respective steps in each of the flowcharts in the specification may be performed in a different order, or a plurality of steps may be performed at the same time, or the order of performing the respective steps may be changed every time the processing in each of the flowchart is performed, without departing from the features of the respective steps.

The present invention is not limited to the embodiment described above, and various modifications can be made without departing from the gist of the present invention.

What is claimed is:

1. An inspection apparatus that acquires images of a plurality of objects to be inspected, comprising:
a feature detection section for detecting first feature portions of at least two objects among the plurality of objects from the images, based on a first condition;
a feature discrimination section for discriminating a first feature portion of a first object and a first feature portion of a second object, based on the first feature portions of the at least two objects;
a defect detection section for detecting a first defect portion of the first object and a first defect portion of the second object, based on the first feature portion of the first object and the first feature portion of the second object; and
a display section for displaying information indicative of the first defect portion of the first object and information indicative of the first defect portion of the second object together with the images.

2. The inspection apparatus according to claim 1, wherein
the feature detection section detects second feature portions of the at least two objects from the images, based on a second condition,
the feature discrimination section discriminates a second feature portion of the first object and a second feature portion of the second object, based on the second feature portions of the at least two objects,
the defect detection section detects a second defect portion of the first object and a second defect portion of the second object, based on the second feature portion of the first object and the second feature portion of the second object, and
the display section displays information indicative of the second defect portion of the first object and information indicative of the second defect portion of the second object together with the images.

3. The inspection apparatus according to claim 2, wherein the display section displays information indicative of the first defect portions of the first and second objects and information indicative of the second defect portions of the first and second objects together with the images.

4. The inspection apparatus according to claim 1, wherein the information indicative of the first defect portions of the first and the second objects is recorded in the same file in which the images are recorded.

5. The inspection apparatus according to claim 2, wherein the information indicative of the second defect portions of the first and the second objects is recorded in the same file in which the images are recorded.

6. The inspection apparatus according to claim 1, wherein the information indicative of the first defect portion of the first object and the information indicative of the first defect portion of the second object are displayed so as to be distinguishable from each other.

7. The inspection apparatus according to claim 2, wherein the information indicative of the second defect portion of the first object and the information indicative of the second defect portion of the second object are displayed so as to be distinguishable from each other.

8. A defect detection method using an inspection apparatus that acquires images of a plurality of objects to be inspected, comprising:
detecting first feature portions of at least two objects among the plurality of objects from the images, based on a first condition;
discriminating a first feature portion of a first object and a first feature portion of the second object, based on the first feature portions of the at least two objects;
detecting a first defect portion of the first object and a first defect portion of the second object, based on the first feature portion of the first object and the first feature portion of the second object; and
displaying information indicative of the first defect portion of the first object and information indicative of the first defect portion of the second object together with the images.

9. The defect detection method using the inspection apparatus according to claim 8, further comprising:
detecting second feature portions of the at least two objects from the images, based on a second condition;
discriminating a second feature portion of the first object and a second feature portion of the second object, based on the second feature portions of the at least two objects;
detecting a second defect portion of the first object and a second defect portion of the second object, based on the second feature portion of the first object and the second feature portion of the second object; and
displaying information indicative of the second defect portion of the first object and information indicative of the second defect portion of the second object together with the images.

10. The defect detection method using the inspection apparatus according to claim 9, further comprising,
displaying information indicative of the first defect portions of the first and the second objects and information indicative of the second defect portions of the first and the second objects together with the images.

11. The defect detection method using the inspection apparatus according to claim 8, wherein the information indicative of the first defect portions of the first and the second objects are recorded in the same file in which the images are recorded.

12. The defect detection method using the inspection apparatus according to claim 9, wherein the information indicative of the second defect portions of the first and second objects are recorded in the same file in which the images are recorded.

13. The defect detection method using the inspection apparatus according to claim 8, wherein the information indicative of the first defect portion of the first object and the information indicative of the first defect portion of the second object are displayed so as to be distinguishable from each other.

14. The defect detection method using the inspection apparatus according to claim 9, wherein the information indicative of the second defect portion of the first object and the information indicative of the second defect portion of the second object are displayed so as to be distinguishable from each other.
